(19) United States
(12) Patent Application Publication
(10) Pub. No.: US 2026/0071448 A1
(43) Pub. Date: Mar. 12, 2026

(54) MODULAR LADDER SYSTEMS AND METHODS THEREOF

(71) Applicant: ASM IP Holding B.V., Almere (NL)

(72) Inventor: Senthil Sivaraman, Yokohama-shi (JP)

(21) Appl. No.: 19/321,646

(22) Filed: Sep. 8, 2025

Related U.S. Application Data
(60) Provisional application No. 63/693,673, filed on Sep. 11, 2024.

(51) Int. Cl. E04G 1/30; E04G 1/24; E04G 5/14; E06C 1/39; E06C 1/397; E06C 7/16; E06C 7/18

(52) U.S. Cl. CPC E04G 1/30; E04G 5/141; E06C 1/39; E06C 7/16; E04G 2001/242; E06C 1/397; E06C 7/182; E06C 7/183

(57) ABSTRACT

A modular ladder system is provided. The modular ladder system includes a vertical ladder assembly including a vertical support with a ladder bridge mount that is configured to dock with a first section of the platform and an angled ladder. The vertical support may also include one or more adaptable parts that is configured to provide a fall prevention barrier according to a shape of the process module. The adaptable part may be a foldable hinged step cover that couples with a second section of the platform or one or more guard rails that rest below the ladder bridge mount in a stowed position and is coupled with the ladder bridge mount. Further, the vertical support and the angled ladder may be detachable. The angled ladder may include an extension plate that provides a bridge between ladder bridge mount and a swing gate of the ladder system.

### CROSS-REFERENCE TO RELATED APPLICATION(S)

This Application claims the benefit of U.S. Provisional Application 63/693,673 filed on Sep. 11, 2024, the entire contents of which are incorporated herein by reference.

### FIELD

The present disclosure relates generally to systems and methods for preventing falls from semiconductor processing systems, such as during the installation and/or removal of modules or other tools for maintenance from semiconductor processing systems.

### BACKGROUND

Semiconductor processing system platform commonly include an equipment front-end module (EFEM) coupled to process modules through a wafer transfer chamber and a load lock chamber. The wafer transfer chamber may be fitted with plating to provides access to portions of the platform for service, such as to gas panels on the process modules and filters housed within the EFEM. The plating is typically accessed by a ladder from the floor below the platform. The ladder is coupled to the platform in a service alley defined between the load lock chamber and process modules. The ladder once installed for service enables maintainers to mount the platform and access to the process modules and/or EFEM from the plating supported above the wafer transfer chamber.

Different process modules typically have different footprints. Consequently, the service alley may have different shapes and sizes in platforms having differently sized process modules, and different platforms therefore may require different ladders. Supporting different platforms with different ladders adds cost and complexity to maintain the platforms, for example due to the need to store different ladders for different platform at a given site and/or for the service organization to coordinate for the proper ladder types to be available according to the service schedule for various platforms (i.e., various process modules of various platforms) at a given customer site. Accordingly, there is a need for improved modular ladder assembly that is able to accommodate various types of platforms and process modules while also ensuring safety during use of the modular ladder assembly.

Any discussion, including discussion of problems and solutions, set forth in this section, has been included in this disclosure solely for the purpose of providing a context for the present disclosure, and should not be taken as an admission that any or all of the discussion was known at the time the invention was made or otherwise constitutes prior art.

### SUMMARY

A modular ladder system for access to a process module on a semiconductor process system is provided. The modular ladder system includes a vertical ladder assembly having a vertical support and an angled ladder. The modular ladder system further includes a ladder bridge mount coupled to the vertical ladder. The ladder bridge mount is configured to dock with at least one section of a platform on the semiconductor process system. The modular ladder system further includes a swing gate fixed at the top of the vertical ladder assembly. The modular ladder system further includes at least one adaptable part coupled to the ladder bridge mount. The adaptable part is configured to provide a fall prevention barrier between the ladder and the service alley based on shape of the process module.

A method of deploying a fall prevention system using a modular ladder system is provided. The method includes determining the type of processing module accommodated in a semiconductor processing system. The method further includes deploying an adaptable part on the modular ladder assembly based on the determined type of processing module. The method further includes attaching the modular ladder assembly to a section of a platform of the semiconductor processing system.

A fall prevention system is provided. A fall prevention system includes a modular ladder system for access to a process module on a semiconductor process system. The modular ladder system includes a vertical support having a plurality of leg supports and a ladder bridge mount support over the plurality of leg supports. The modular ladder system further includes a base frame coupled to the ladder bridge mount. The modular ladder system further includes a ladder coupled to the base frame and the ladder rests at the base frame at an angle. Fall prevention system further includes at least one adaptable part coupled to the ladder bridge mount. The at least one adaptable part is configured to provide a fall prevention barrier between the ladder and a service alley.

According to some embodiments, a modular ladder system configured to provide access to a process module of a semiconductor process system comprising: a vertical ladder assembly comprising a vertical support and an angled ladder, the vertical support comprising a ladder bridge mount that is configured to dock with a first section of the semiconductor process system; a swing gate secured to an upper end of the angled ladder; and at least one adaptable part coupled to the ladder bridge mount. The at least one adaptable part is configured to provide a fall prevention barrier between the vertical ladder assembly and a service alley.

In some embodiments, the at least one adaptable part comprises a foldable hinged step cover that is operable to transition between an inward position and an outward position, when the foldable hinged step cover is in the inward position, a portion of a top surface of the foldable hinged step cover faces a top surface of the ladder bridge mount, and when the foldable hinged step cover is in the outward position, the top surface of the foldable hinged step cover and the top surface of the ladder bridge mount are coplanar with each other, and the foldable hinged step cover is further coupled to a second section of the semiconductor process system.

In some embodiments, the at least one adaptable part comprises a first guard rail that is operable to transition between a stowed position and a deployed position, when the first guard rail is in the stowed position, the first guard rail is disposed below the ladder bridge mount, and when the first guard rail is in the deployed position, the ladder bridge mount and the first guard rail are perpendicular to each other. In some embodiments, when the first guard rail is in the deployed position, the first guard rail is configured to attach to a first side of the swing gate.

In some embodiments, the at least one adaptable part further comprises a second guard rail that is operable to transition between a stowed position and a deployed position, when the second guard rail is in the stowed position, the second guard rail is disposed below the ladder bridge mount, and when the second guard rail is in the deployed position, the ladder bridge mount and the second guard rail are perpendicular to each other. In some embodiments, when the second guard rail is in the deployed position, the second guard rail is configured to attach to a second side of the swing gate.

In some embodiments, the vertical support and the angled ladder are configured to be detachably connected to one another. The angled ladder comprises an extension plate pivotably mounted to the angled ladder at a position between the swing gate and the ladder bridge mount. The extension plate is alignable with the ladder bridge mount. The at least one adaptable part comprises a second guard rail that is operable to transition between a stowed position and a deployed position, and when the second guard rail is in the deployed position, the second guard rail is perpendicular to the extension plate.

In some embodiments, the angled ladder comprises a base frame and a ladder, and the ladder is supported by and attached to the base frame at an angle of about 75 degrees.

In some embodiments, the foldable hinged step cover comprises a plate rest to rest over the second section of the semiconductor process system, and the plate rest is attached to the second section of the semiconductor process system.

According to some embodiments, a method of deploying a modular ladder system, the method comprises: determining a type of a processing module of a semiconductor processing system; deploying an adaptable part of the modular ladder system according to the type of the processing module; and then attaching the modular ladder system to a first section of the semiconductor processing system.

In some embodiments, deploying the adaptable part of the modular ladder system comprises: providing a foldable hinged step cover coupled to a ladder bridge mount of the modular ladder system; and positioning the foldable hinged step cover to an inward position such that a portion of a top surface of the foldable hinged step cover faces a top surface of the ladder bridge mount. The method further comprises, after attaching the modular ladder system to the first section of the semiconductor processing system, positioning the foldable hinged step cover in an outward position such that the top surface of the foldable hinged step cover is coplanar with the top surface of the ladder bridge mount and is coupled with a second section of the semiconductor processing system.

In some embodiments, deploying the adaptable part of the modular ladder system comprises: providing a first guard rail coupled to a ladder bridge mount of the modular ladder system; and stowing the first guard rail in a stowed position below the ladder bridge mount. The method further comprises: after attaching the modular ladder system to the first section of the semiconductor processing system, deploying the first guard rail in a deployed position, according to the type of the processing module, such that the first guard rail and the ladder bridge mount are perpendicular to each other; and attaching the first guard rail to a first side of a swing gate of the modular ladder system.

In some embodiments, deploying the adaptable part on the modular ladder system further comprises: providing a second guard rail coupled to the ladder bridge mount; and stowing the second guard rail in a stowed position below the ladder bridge mount. The method further comprises: after attaching the modular ladder system to the first section of the semiconductor processing system, deploying the second guard rail in a deployed position, according to the type of the processing module, such that the second guard rail and the ladder bridge mount are perpendicular to each other; and then attaching the second guard rail to a second side of the swing gate of the modular ladder system.

In some embodiments, deploying the adaptable part of the modular ladder system comprises: detaching a vertical support and an angled ladder of the modular ladder system; and deploying an extension plate to be pivotably fixed to the angled ladder at a location between a swing gate and a ladder bridge mount of the modular ladder system. A top surface of the extension plate is coplanar with a top surface of the ladder bridge mount.

In some embodiments, attaching the modular ladder system to the first section of the semiconductor processing system comprises utilizing a latch to attach a ladder bridge mount of the modular ladder system to the first section of the semiconductor processing system.

According to some embodiments, a fall prevention system comprising: a modular ladder system configured to provide access to a process module of a semiconductor process system. The modular ladder system comprises: a vertical support comprising a plurality of leg supports and a ladder bridge mount supported by the plurality of leg supports; a base frame coupled to the ladder bridge mount; a ladder coupled to the base frame, the ladder being supported by and attached to the base frame at an angle; and at least one adaptable part coupled to the ladder bridge mount. The at least one adaptable part is configured to provide a fall prevention barrier between the modular ladder system and a service alley.

In some embodiments, the at least one adaptable part coupled to the ladder bridge mount comprises: at least one guard rail coupled to a first side of the ladder bridge mount; and/or a foldable hinged step cover coupled to a second side of the ladder bridge mount.

In some embodiments, the ladder bridge mount is configured to dock with a section of a semiconductor processing system.

This summary is provided to introduce a selection of concepts relating to this technology in a simplified form. These concepts are described in further detail in the detailed description of examples of the disclosure below. This summary is not intended to identify key features or essential features of the claimed subject matter, nor is it intended to be used to limit the scope of the claimed subject matter.

### BRIEF DESCRIPTION OF DRAWING

These and other features, aspects, and advantages of the invention disclosed herein are described below with reference to the drawings of example embodiments, which are intended to illustrate and not to limit the invention.

FIGS. 1A and 1B illustrate perspective views of a modular ladder system in accordance with some embodiments of the invention.

FIGS. 2A, 2B, 2C and 2D illustrate various views illustrating a first configuration of deploying an adaptable part of the modular ladder system of FIGS. 1A and 1B in accordance with some embodiments of the invention.

FIGS. 3A, 3B, 3C, 3D and 3E illustrate various views illustrating a second configuration of deploying an adaptable part of the modular ladder system of FIGS. 1A and 1B in accordance with some embodiments of the invention.

FIGS. 4A, 4B, 4C and 4D illustrate various views illustrating a third configuration of deploying an adaptable part of the modular ladder system of FIGS. 1A and 1B in accordance with some embodiments of the invention.

FIGS. 5A, 5B, 5C, 5D and 5E illustrate various views illustrating a fourth configuration of deploying an adaptable part of the modular ladder system of FIGS. 1A and 1B in accordance with some embodiments of the invention.

FIG. 6 illustrates a flow diagram of a method for deploying a fall prevention system using the modular ladder system of FIGS. 1A and 1B in accordance with some embodiments of the invention.

It will be appreciated that elements in the figures are illustrated for simplicity and clarity and have not necessarily been drawn to scale. For example, the relative size of some of the elements in the figures may be exaggerated relative to other elements to help improve understanding of illustrated embodiments of the present disclosure.

### DETAILED DESCRIPTION

Reference will now be made to the drawings wherein like reference numerals identify similar structural features or aspects of the subject disclosure. The systems and methods of the present disclosure may be in semiconductor processing systems employed to fabricate semiconductor devices, such as in semiconductor processing systems employed to deposit material layers using chemical vapor deposition (CVD) and atomic layer deposition (ALD) techniques during the fabrication of logic and memory devices, though the present disclosure is not limited to any semiconductor processing operation or to the fabrication of any particular semiconductor device in general.

As used herein, the term “substrate” may refer to any underlying material or materials, including any underlying material or materials that may be modified, or upon which, a device, a circuit, or a film may be formed. The “substrate” may be continuous or non-continuous; rigid or flexible; solid or porous; and combinations thereof. The substrate may be in any form, such as a powder, a plate, or a workpiece. Substrates in the form of a plate may include wafers in various shapes and sizes. Wafers may be 200 millimeters in diameter, 300 millimeters, or even 450 millimeters in diameter. Substrates may be formed from one or more semiconductor materials including by way of non-limiting example silicon, silicon germanium, silicon oxide, gallium arsenide, gallium nitride and silicon carbide.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. As used herein the term “and/or” includes any and all combinations of one or more of the associated listed items.

A substrate processing system (also referred to as a platform) may include, for example, a Front Opening Unified Pod (FOUP), an equipment front end module (EFEM), a load lock chamber, one or more substrate handling chambers (SHC), one or more processing modules, and a control processor (that further includes memory). SHC may be fitted with plating to provides access to portions of the platform for service, such as to gas panels on the process modules and filters housed within the EFEM. The plating is typically accessed by a ladder from the floor below the platform. The ladder coupling to the platform in a service alley is defined between the load lock chamber and process modules. As used herein, the term “platform” may also refer to an element of the substrate processing system, such as SHC and EFEM.

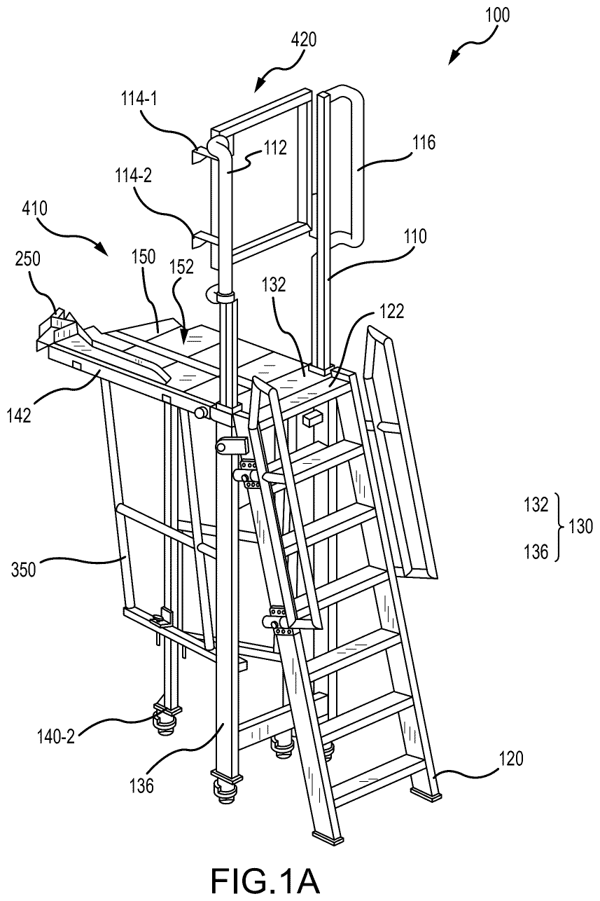

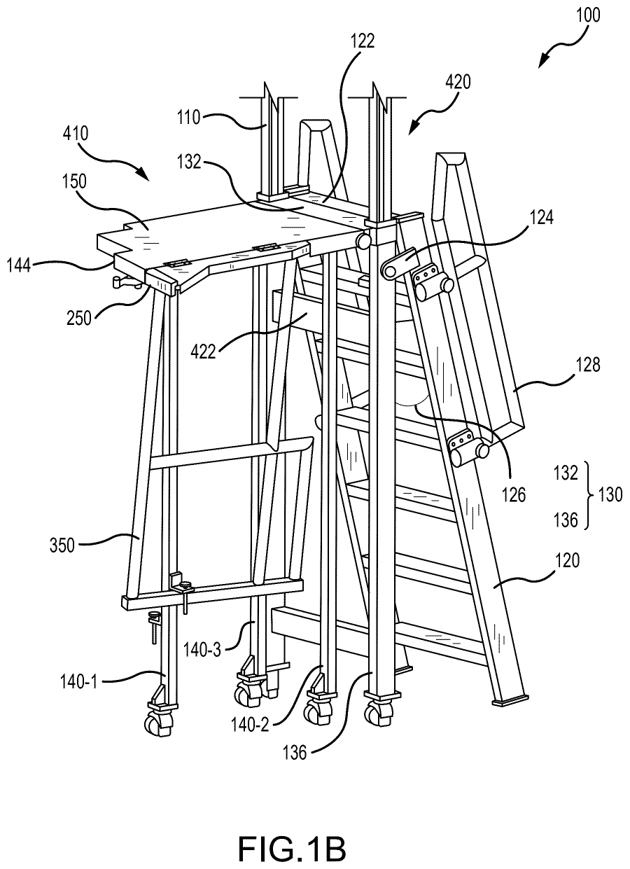

Referring to FIGS. 1A and 1B, two perspective views of a modular ladder system 100 are shown. Modular ladder system 100 includes a vertical ladder assembly including a vertical support 410 and angled ladder 420. In example embodiments, angled ladder 420 includes a base frame 130. Base frame 130 includes back legs 136 (also referred to as legs) extending in a vertical direction. Legs 136 may be separated by a back ladder top surface 132 (also referred to as a top surface of a back ladder) of base frame 130. Back ladder top surface 132 is orthogonal to legs 136. As used herein, “orthogonal” may be interchangeable with “perpendicular”, and “a top surface” may be also referred to as an upper surface.

Angled ladder 420 includes a ladder section 120 having steps 122. Ladder section 120 rests against base frame 130 such that top step 122 of ladder section 120 abuts back ladder top surface 132. As shown in FIGS. 1A and 1B, top step 122 and back ladder top surface 132 are aligned. In some embodiments, a top surface of the top step 122 and the back ladder top surface 132 may be coplanar with each other, as illustrated in FIGS. 1A and 1B. In example embodiments, ladder section 120 rests against base frame 130 at an angle 126. In example embodiments, angle 126 is about 75 degrees. In example embodiments, base frame 130 and ladder section 120 are attached by a latch 124. Further, in example embodiments, ladder section 120 includes a ladder support 128 that may be used by a technician to climb up the ladder section 120. As used herein, a top surface may be interchangeable with an upper surface.

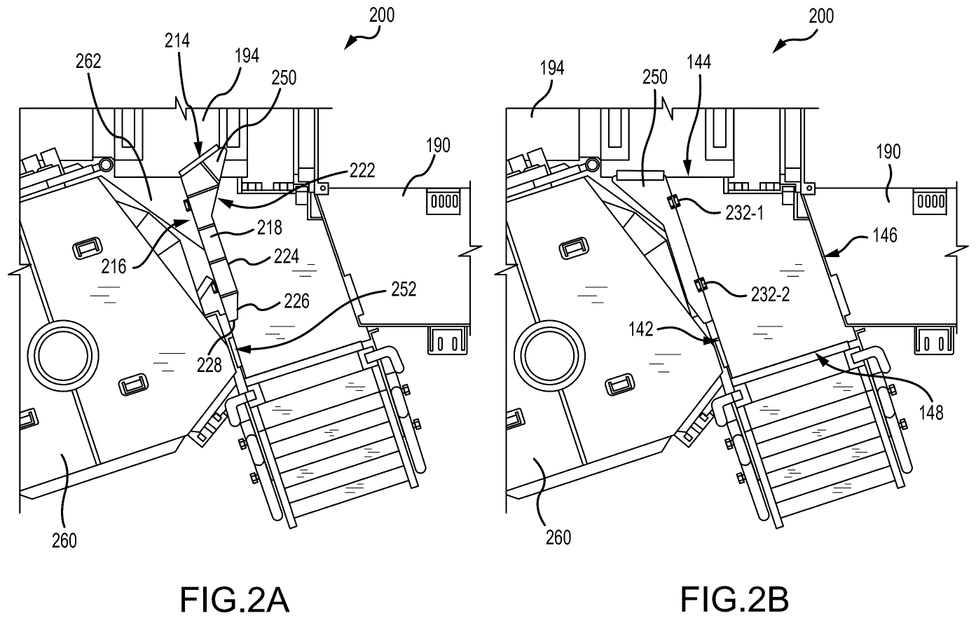

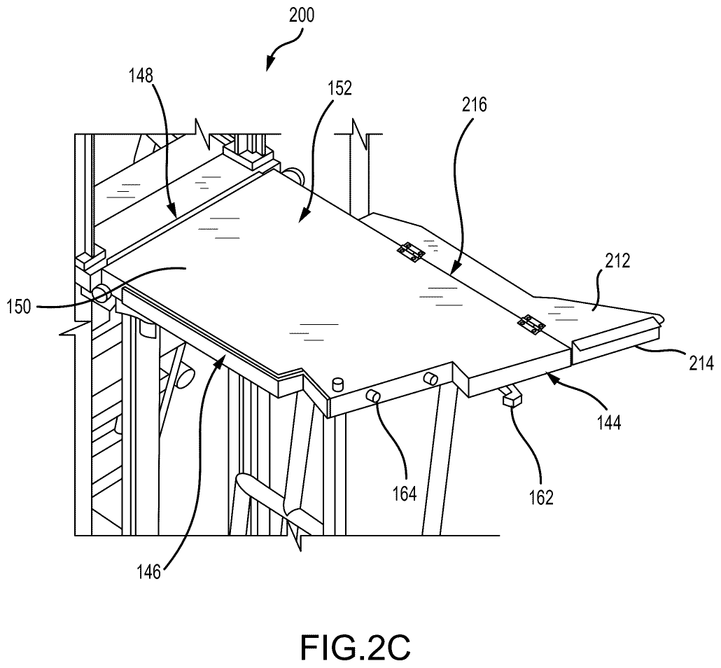

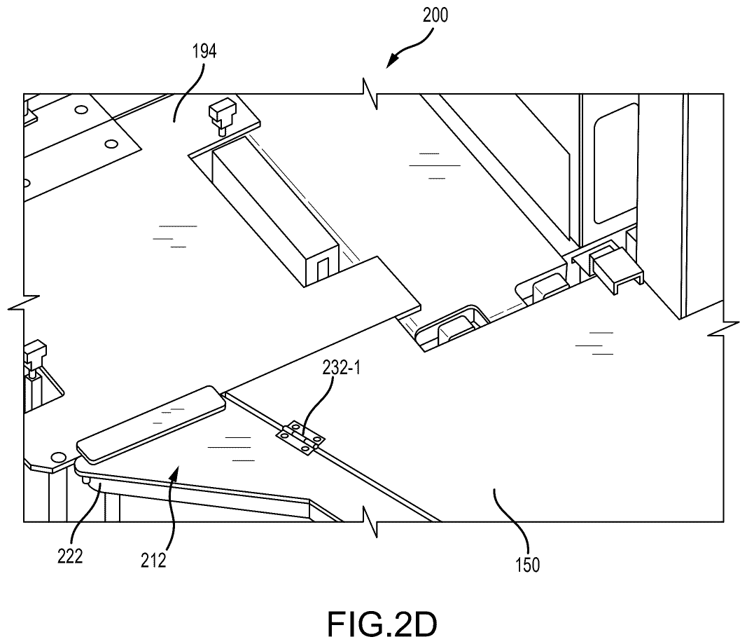

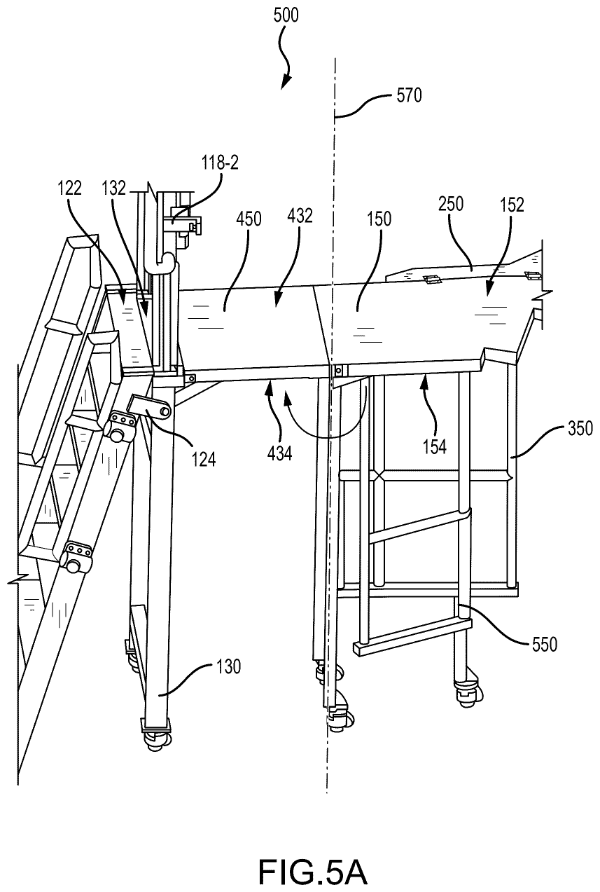

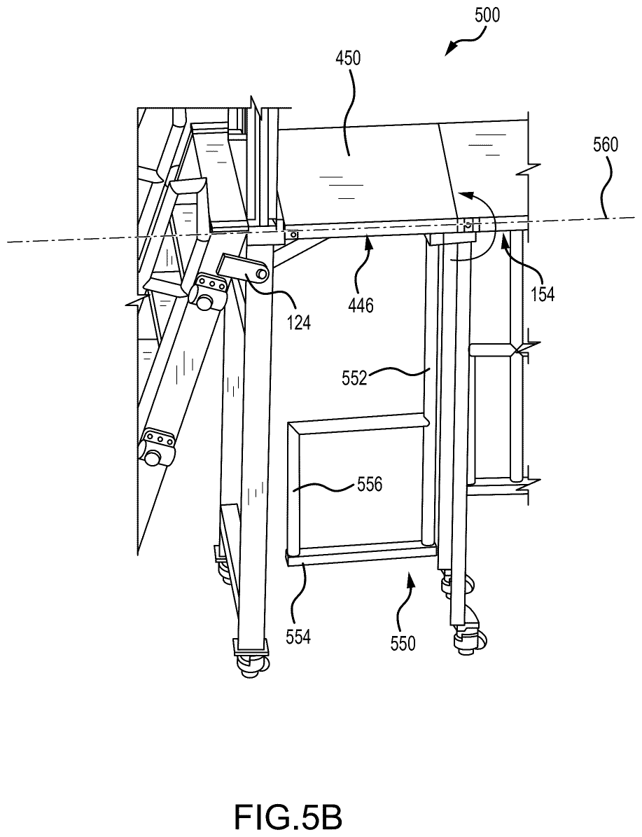

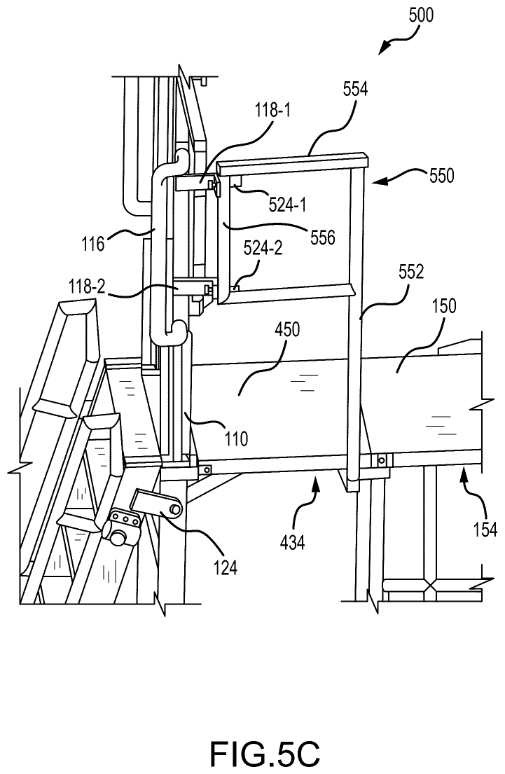

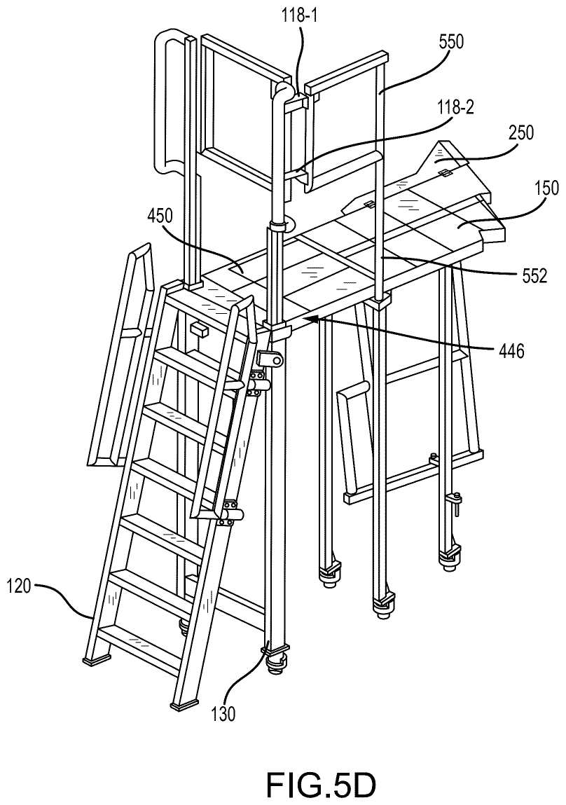

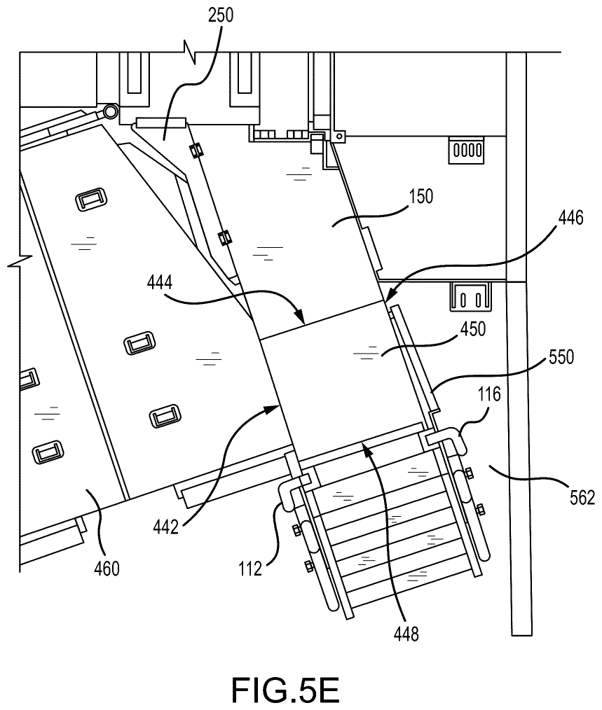

Vertical support 410 includes a ladder bridge mount 150. Ladder bridge mount 150 has a top surface 152 (e.g., a top surface 152 in FIG. 2C) and a bottom surface 154 (e.g., a bottom surface 154 in FIG. 5). Ladder bridge mount 150 further comprises a first side surface 142, a second side surface 144, a third side surface 146 (e.g., a third side surface 146 in FIG. 2C) and a fourth side surface 148 (e.g., a fourth side surface 148 in FIG. 2C). Top surface 152 and bottom surface 154 (e.g., a bottom surface 154 in FIG. 5A) are separated by side surfaces 142, 144, 146 and 148. Ladder bridge mount 150 is supported by a plurality of legs 140-1, 140-2 and 140-3. In example embodiments, ladder bridge mount 150 is supported by three legs 140-1, 140-2 and 140-3. Ladder bridge mount 150 is attached to back ladder top surface 132 of base frame 130. Back ladder top surface 132 is aligned with ladder bridge mount 150. In some embodiments, the back ladder top surface 132 and the top surface 152 of ladder bridge mount 150 may be coplanar with each other, and back ladder top surface 132 and top step 122 may be coplanar with each other, as illustrated in FIGS. 1A and 1B.

Modular ladder system 100 further includes a swing gate 110. In example embodiments, swing gate 110 is aligned vertically with base frame 130 of angled ladder 420. As shown in FIGS. 1A and 1B, swing gate 110 is orthogonal to ladder bridge mount 150. In example embodiments, swing gate 110 further includes a first side handle 112 and a second handle 116. Further, in example embodiments, first side handle 112 includes one or more attachment extensions 114-1 and 114-2. In example embodiments, second side handle 116 includes one or more attachment extensions 118-1 and 118-2 (e.g., attachment extensions 118-1 and 118-2 in FIG. 5C). Extensions 114-1 and 114-2 protrude horizontally from first side handle 112 and extensions 118-1 and 118-2 protrude horizontally from second side handle 116.

Modular ladder assembly 100 is configured to slide into a service alley between processing module (such as 260 in FIGS. 2A and 2B) and a EFEM 190 (e.g., EFEM 190 in FIGS. 2A and 2B). Ladder bridge mount 150 further includes one or more docking pins 164 (e.g., docking pins 164 in FIG. 2C) and a latch 162 (e.g., a latch 162 in FIG. 2C) on surface 144. Docking pin 164 may be used as a guide to dock modular ladder assembly 100 to at least one section of the platform (such as SHC). A latch 162 locks modular ladder assembly 100 into place to attach to ladder bridge mount 150 to platform.

Different process modules typically have different footprints. As a consequence, the service alley may have different shapes and sizes in platforms having differently sized process modules. Modular ladder assembly 100 may include one or more adaptable parts that are deployed to prevent a fall from the ladder bridge mount 150 into an empty space resultant from the shape or size of a respective process module.

For example, FIGS. 2A-2D provide various views illustrating a first configuration 200 of deploying an adaptable part of modular ladder assembly 100. As shown in FIGS. 2A and 2B, when modular ladder assembly 100 docks to platform 194 (such as a load lock), side 146 of ladder bridge mount 150 aligns with EFEM 190. However, as shown in FIG. 2A, while at least one edge 252 of processing module 260 abuts with a part of side 142 of the ladder bridge mount 150, a space 262 remains uncovered between ladder bridge mount 150 and processing module 260. Space 262 may risk injury for technicians working in this workspace in an event of fall from top of the ladder bridge mount 150, processing module 260, or any other elevated section of the platform. Accordingly, this space may be covered using an adaptable part 250 illustrated in FIG. 2A.

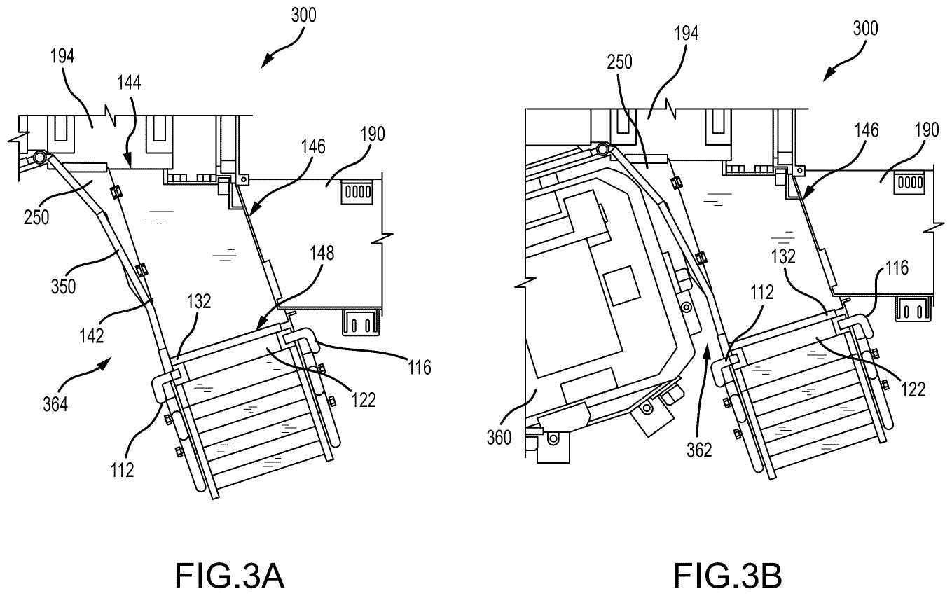

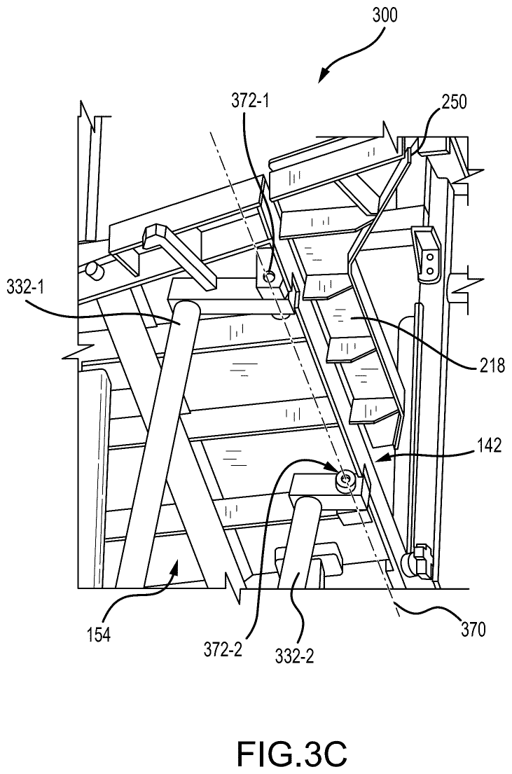

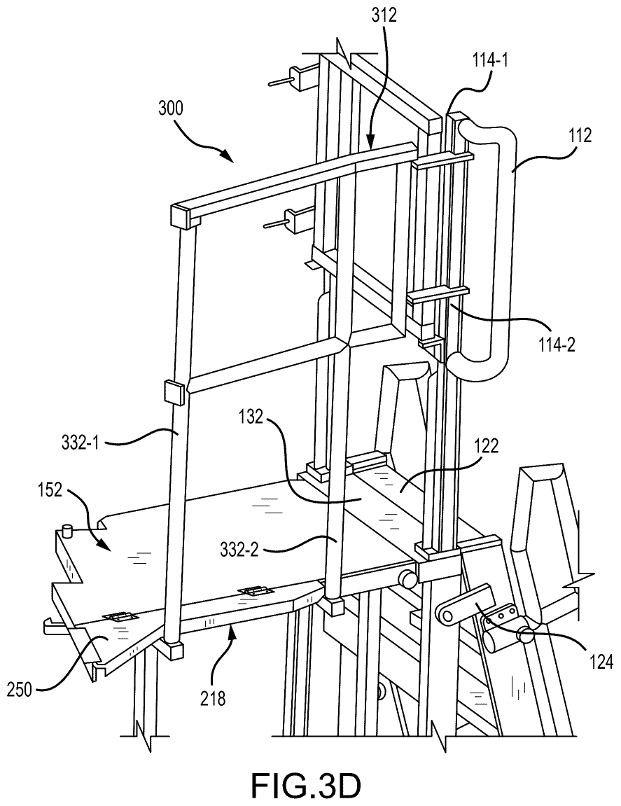

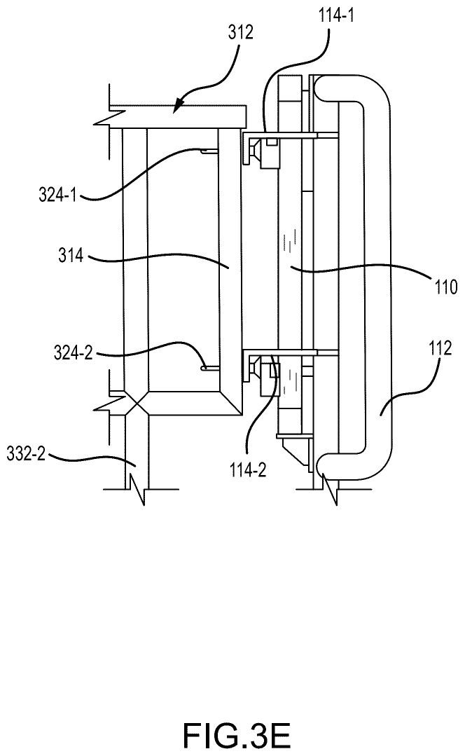

Adaptable part 250 is a foldable hinged step cover (also referred to as a step cover). As shown in FIGS. 2A-2D, side 216 of step cover 250 is coupled with side 142 and attached with one or more hinges 232-1 and 232-2. Accordingly, step cover 250 is configured to flip in an inward position (see FIG. 2A) or an outward position (see FIG. 2B). Step cover 250 is operable to transition between the inward position and the outward position. Step cover 250 has a top surface 212 and a bottom surface 218 (see FIG. 3C). Top surface 212 and bottom surface 218 is separated by side 216. In example embodiments, hinged step cover 250 may have a shape the same as or similar to space 262. In example embodiments, top surface 212 and bottom surface 218 are also separated by sides 214, 222, 224, 226 and 228. When step cover 250 is in an inward position, at least a portion of top surface 212 is facing top surface 152. And when step cover 250 is in an outward position, top surface 212 of step cover 250 and top surface 152 are adjacent to each other. In some embodiments, when step cover 250 is in an outward position, top surface 212 of step cover 250 and top surface 152 may be coplanar with each other, as illustrated in FIG. 2C.

Accordingly, prior to docking and attaching ladder bridge mount 150 with a section of the platform 194, step cover 250 may be flipped inward position. Modular ladder assembly 100 is then slid through to dock and attach ladder bridge mount 150. Once the ladder bridge mount 150 is attached, step cover 250 may be flipped to an outward position to cover space 262. Accordingly, the foldable hinged step cover 250 allows the modular ladder assembly 100 to slide through the service alley without major modifications to a ladder assembly.

FIGS. 3A-3E provide various views illustrating a second configuration 300 of deploying an adaptable part of modular ladder system 100. FIG. 3A shows an example embodiment, which does not have any process modules leaving space 364. FIG. 3B shows an example embodiment, where the process module is not in contact with modular ladder assembly 100 when docked to the platform 194. As shown in FIG. 3B, such an embodiment results in significant amount of gap 362, which may risk injury for technicians working in this workspace in an event of fall from top of the ladder bridge mount 150. Accordingly, providing an adaptable part, such as, a left side guard rail 350 (also referred to as a first guard rail) may prevent a fall.

Left side guard rail 350 may be in a stowed position or a deployed position. Left side guard rail 350 may be operable to transition between the stowed position or the deployed position. As shown in FIG. 3C, left side guard rail 350 is in a stowed position. In example embodiments, left side guard rail 350 is stowed under ladder bridge mount 150. Left side guard rail 350 is attached using one or more hinges 372-1 and 372-2. Left side guard rail 350 is configured to rotate upward about axis 370. In example embodiments, axis 370 coincides with side 142 of ladder bridge mount 150.

Left side guard rail 350 may have two legs, a first left guard rail leg 332-1 and a second left guard rail leg 332-2. In FIG. 3D, left side guard rail 350 is in a deployed position. Left side guard rail 350 can be rotated upward about axis 370. Legs 332-1 and 332-2 (and consequently left side guard rail 350) are orthogonal to the ladder bridge mount 150.

In example embodiments, left side guard rail 350 is configured to be attached to swing gate 110. Specifically, in example embodiments, left side guard rail 350 further includes a rectangular section 312. As shown in FIG. 3E, rectangular section 312 includes at least a part of second left guard rail leg 332-2. In example embodiments, the rectangular section 312 may be attached to swing gate 110 at one or more attachment extensions 114-1 and 114-2. In further example embodiments, attachment extension 114-1 is attached to rectangular section 312 using latch pin 324-1 and attachment extension 114-2 is attached to rectangular section 312 using latch pin 324-2. Consequently, left side guard rail 350 is attached to swing gate 110. Thus, left side guard rail 350 provides support for technicians working in this workspace and mitigates the risk of falls from the ladder bridge mount 150.

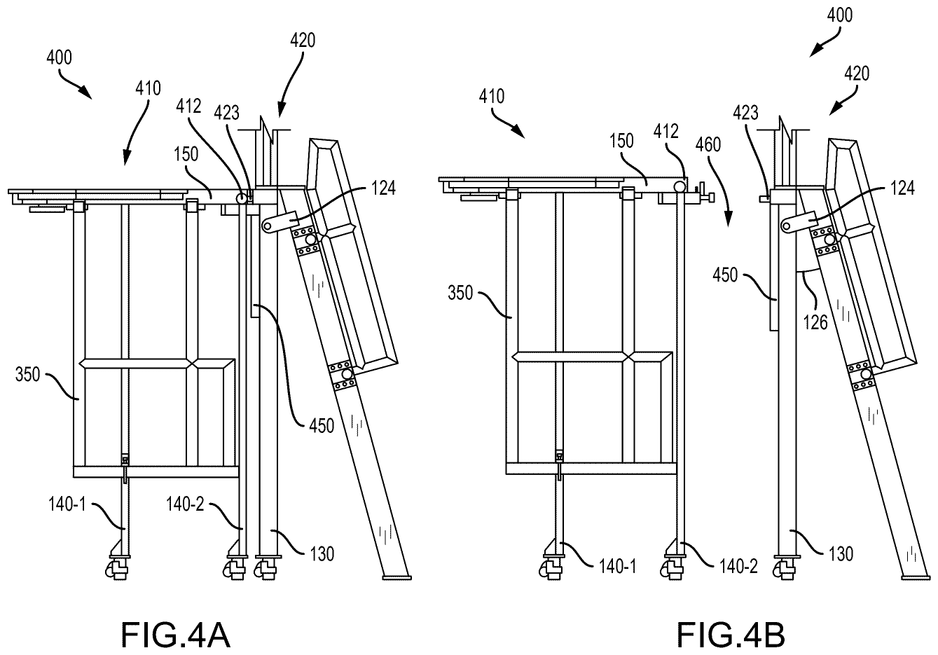

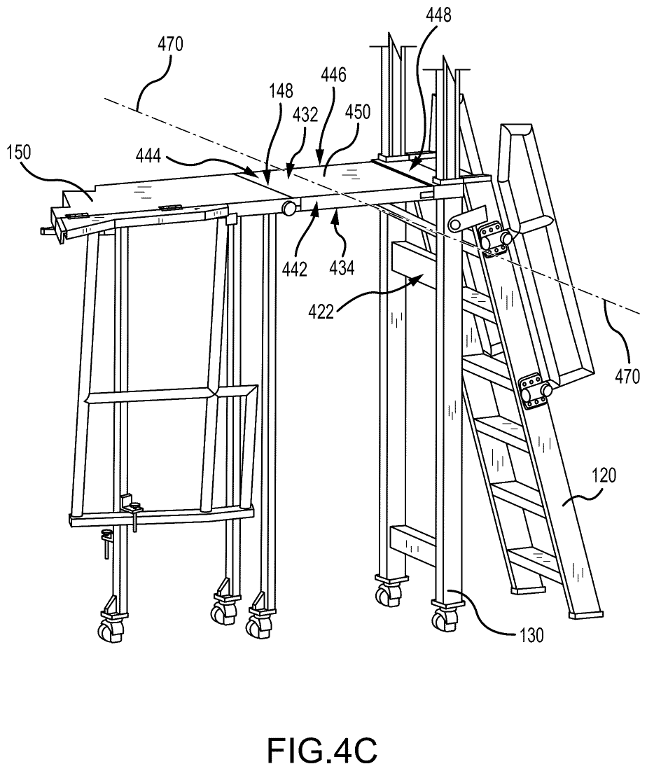

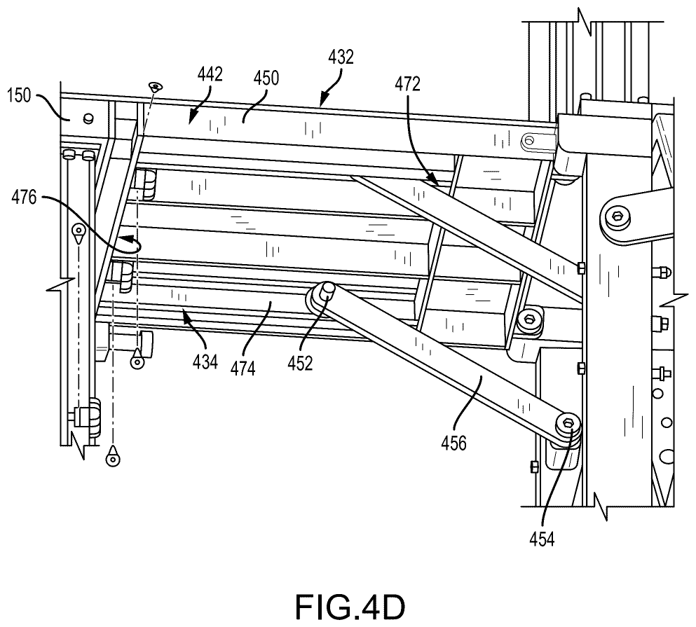

FIGS. 4A-4D provide various views illustrating a third configuration 400 of deploying an adaptable part of modular ladder system 100. In some embodiments, process modules (e.g., a processing module 460 in FIG. 5E) are too large (e.g., longer than the length of ladder bridge mount 150 as illustrated in FIG. 5E) and modular ladder assembly 100 may need to extend to access part of processing module. FIGS. 4A-4D provide a configuration to extend the ladder bridge mount 150.

Modular ladder system 100 includes a vertical ladder assembly including a vertical support 410 and angled ladder 420. An extension plate 450 may be in a stowed position or a deployed position. Extension plate 450 may be operable to transition between the stowed position and the deployed position. As shown in FIG. 4B, extension plate 450 is in a stowed position. In example embodiments, extension plate 450 is stowed under back ladder top surface 132 of base frame 130 of angled ladder 420. As further shown in FIGS. 4A-4D, extension plate 450 remains stowed against inner back surface 422. In some embodiments, the vertical support 410 and the angled ladder 420 are configured to be detachably connected to one another, as illustrated in FIG. 4B.

As shown in FIGS. 4A-4D, extension plate 450 has a top surface 432 and a bottom surface 434. Extension plate 450 is further defined by four sides 442, 444, 446 and 448. Bottom surface 434 further includes sliding recess(es) 474 that extend from a first inner edge 472 to a second inner edge 476. In the stowed position, first inner edge 472 is proximate to top surface 432 and second inner edge 476 is distant from top surface 432 compared to first inner edge 472.

As shown in FIG. 4A, in example embodiments, vertical support 410 is coupled to angled ladder 420 at an attachment point. Specifically, vertical support 410 includes an attachment point 412 and angled ladder 420 includes an attachment protrusion 423. Attachment point 412 is coupled to attachment protrusion 423 to form the modular ladder system 100. Accordingly, vertical support 410 and angled ladder 420 can be detached at attachment point 412. FIG. 4B illustrates vertical support 410 and angled ladder 420 as separated from each other. Extension plate 450 can be extended into space 460 and attached to vertical support 410 to extend ladder bridge mount.

Extension plate 450 is connected to the base frame at hinges 454. Extension plate 450 further includes sliding bar 456 that extends from hinge 454 to sliding joint 452. That is, one end of sliding bar 456 is connected to hinge 454 and another end of sliding bar 456 is connect to hinge sliding joint 452. Sliding joint 452 is configured to move between inner edges 472 and 476.

When extension plate 450 is in the stowed position, sliding joint 452 is proximate to inner edge 476. As the extension plate 450 moves from a stowed position to a deployed position, sliding joint 452 also moves along sliding recess 474. When the extension plate 450 is in a deployed position, sliding joint 452 is proximate to inner edge 472. Hinges 454 move about an axis 470. Consequently, extension plate 450 moves in a deployed position about axis 470 based on the rotation of hinges 454.

When extension plate 450 is in a deployed position, side 148 of ladder bridge mount 150 abuts with side 444 of extension plate 450. Top surface 152 of ladder bridge mount 150 and top surface 432 of extension plate 450 are leveled with each other. Further, in the deployed position, extension plate 450 is adjacent and aligned to back ladder top surface 132 and top step 122. Accordingly, a technician working on the elevated workspace will have an extended leveled mount formed of top step 122, back ladder top surface 132, extension plate 450 and ladder bridge mount 150. Thus, such a configuration will provide easy access for a larger processing module 460 as shown in FIG. 5E. In some embodiment, the top surface 432 of extension plate 450 and the top surface 152 of ladder bridge mount 150 may be coplanar with each other, the top surface 432 of extension plate 450 and the back ladder top surface 132 may be coplanar with each other, and the top surface 432 of extension plate 450 and the top step 122 may be coplanar with each other, as illustrated in FIG. 5A.

However, including an extension plate 450 such as the one in configuration 400 results in an open space 562 on an opposite side. As shown in FIG. 5E, such an embodiment results in significant amount of gap 562 (e.g., a gap 562 in FIG. 5E), which may risk injury for technicians working in this workspace in an event of fall from top of extension plate 450. Accordingly, providing an adaptable part, such as, a right side guard rail 550 (e.g., a right side guard rail 550 in FIG. 5A, also referred to as a second guard rail) may prevent a fall.

FIGS. 5A-5E provide various views illustrating a fourth configuration 500 of deploying an adaptable part, such as right side guard rail 550 of modular ladder system 100. Right side guard rail 550 may be in a first stowed position, a second stowed position or a deployed position. Right side guard rail 550 may be operable to transition between the first stowed position, the second stowed position and deployed position. As shown in FIG. 5A, right side guard rail 550 is in a first stowed position. In example embodiments, right side guard rail 550 is stowed under ladder bridge mount 150. Right side guard rail 550 is configured to flip rightwards about axis 570. As shown in FIG. 5A, axis 570 is parallel to base frame 130 and perpendicular to top surface 432 of extension plate 450.

FIG. 5B illustrates right side guard rail 550 after flipped (e.g., rotated) about axis 570. As shown in FIG. 5B, right side guard rail 550 is in a second stowed position. Right side guard rail 550 is stowed under extension plate 450 and is configured to rotate upward about axis 560. In example embodiments, axis 560 coincides with side 446 of extension plate 450, as illustrated in FIG. 5B.

In FIG. 5C, right side guard rail 550 is in a deployed position. Right side guard rail 550 can be rotated upward about axis 560. In example embodiments, right side guard rail 550 is configured to be attached to swing gate 110. Specifically, in example embodiments, right side guard rail 550 is flag shaped having a leg 552 and a rectangular section 554. Leg 552 is orthogonal to extension plate 450.

As shown in FIG. 5C, rectangular section 554 includes column 556, which is opposite leg 552. In example embodiments, the rectangular section 554 may be attached to swing gate 110 at one or more attachment extensions 118-1 and 118-2. In further example embodiments, attachment extension 118-1 is attached to column 556 using latch pin 524-1 and attachment extension 118-2 is attached to column 556 using latch pin 524-2. Consequently, right side guard rail 550 is attached to swing gate 110 (See also FIG. 5D). Thus, right side guard rail 550 provides support for technicians working in this workspace and mitigates the risk of falls from extension plate 450.

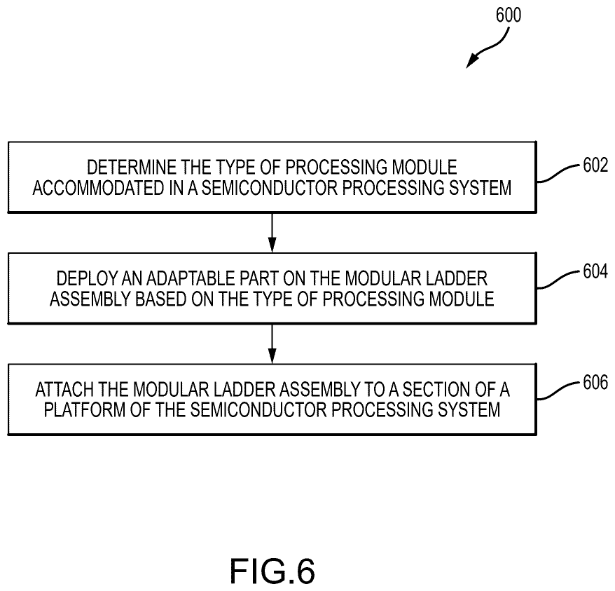

FIG. 6 illustrates a method 600 of deploying a fall prevention system using a modular ladder system, such as modular ladder system 100. Method 600 includes determining the type of processing module accommodated in a semiconductor processing system, as shown with box 602. Method 600 further includes deploying an adaptable part, such as parts 250, 350, 450, 550 on the modular ladder assembly based on the determined type of processing module, such as processing module 260, 360, 460, as shown with box 604. Method 600 further includes attaching the modular ladder assembly to a section of a platform of the semiconductor processing system, as shown with box 606.

In example embodiments, deploying an adaptable part on the modular ladder assembly of method 600 further includes providing a foldable hinged step cover, such as cover 250, coupled to the ladder bridge mount, such as mount 150. Method 600 further includes flipping the foldable hinged step cover to an inward position such that the top surface, such as top surface 212, of the foldable hinged step cover faces the top surface, such as top surface 152 of the ladder mount bridge. After attaching the modular assembly to a section of a platform of the semiconductor processing system, method 600 further includes flipping the foldable hinged step cover to an outward position such that the foldable hinged step cover aligns with the ladder bridge mount. The foldable hinged step cover may be operable to transition between the inward position and the outward position. In some embodiments, when the foldable hinged step cover is in the outward position, a top surface of the foldable hinged step cover and a top surface of the ladder bridge mount may be coplanar with each other.

In example embodiments, deploying an adaptable part on the modular ladder assembly of method 600 further includes coupling a first guard rail, such as guard rail 350, to the ladder bridge mount. In example embodiments, method 600 further includes stowing the first guard rail in a stowed position below the ladder bridge mount. In example embodiments, based on a respective determined processing module, method 600 further includes deploying the first guard rail in the deployed position by flipping the first guard rail abutting a first side of the ladder bridge mount such that the first guard rail and the swing gate are orthogonal to each other and attaching the first guard rail to a swing gate at a first side of the swing gate.

In example embodiments, deploying an adaptable part on the modular ladder assembly of method 600 further includes coupling a second guard rail, such as guard rail 550, to the ladder bridge mount. Method 600 further includes stowing the second guard rail in a stowed position below the ladder bridge mount. In example embodiments, based on a respective determined processing module, method 600 further includes deploying the second guard rail in the deployed position such that the second guard rail and the swing gate are orthogonal to each other. In example embodiments, method 600 further includes attaching the second guard rail to a swing gate at a second side of the swing gate.

In example embodiments, deploying an adaptable part on the modular ladder assembly of method 600 further includes detaching a vertical support, such as support 410, and an angled ladder, such as angled ladder 420 of the modular ladder assembly. Method 600 further includes deploying an extension plate, such as plate 450 to be pivotably fixed to the angled ladder at a location between the swing gate and the ladder bridge mount, wherein the extension plate is aligned with the ladder bridge mount. In some embodiments, a top surface of the extension plate and a top surface of the ladder bridge mount may be coplanar with each other. In example embodiments of method 600, attaching the modular ladder assembly to a section of a platform of the semiconductor processing system further includes utilizing a latch to attach the ladder mount bridge to the section of the platform.

Although this disclosure has been provided in the context of certain embodiments and examples, it will be understood by those skilled in the art that the disclosure extends beyond the specifically described embodiments to other alternative embodiments and/or uses of the embodiments and obvious modifications and equivalents thereof. In addition, while several variations of the embodiments of the disclosure have been shown and described in detail, other modifications, which are within the scope of this disclosure, will be readily apparent to those of skill in the art based upon this disclosure. It is also contemplated that various combinations or sub-combinations of the specific features and aspects of the embodiments may be made and still fall within the scope of the disclosure. It should be understood that various features and aspects of the disclosed embodiments can be combined with, or substituted for, one another in order to form varying modes of the embodiments of the disclosure. Thus, it is intended that the scope of the disclosure should not be limited by the particular embodiments described above.

The subject matter of the present disclosure includes combinations and sub-combinations of systems, configurations, features and/or functions disclosed herein, as well as any and all equivalents thereof.

1. A modular ladder system configured to provide access to a process module of a semiconductor process system, the modular ladder system comprising:
a vertical ladder assembly comprising a vertical support and an angled ladder, the vertical support comprising a ladder bridge mount that is configured to dock with a first section of the semiconductor process system;
a swing gate secured to an upper end of the angled ladder; and
at least one adaptable part coupled to the ladder bridge mount, wherein the at least one adaptable part is configured to provide a fall prevention barrier between the vertical ladder assembly and a service alley.

2. The modular ladder system of claim 1, wherein the at least one adaptable part comprises a foldable hinged step cover that is operable to transition between an inward position and an outward position,
when the foldable hinged step cover is in the inward position, a portion of a top surface of the foldable hinged step cover faces a top surface of the ladder bridge mount, and
when the foldable hinged step cover is in the outward position, the top surface of the foldable hinged step cover and the top surface of the ladder bridge mount are coplanar with each other, and the foldable hinged step cover is further coupled to a second section of the semiconductor process system.

3. The modular ladder system of claim 1, wherein the at least one adaptable part comprises a first guard rail that is operable to transition between a stowed position and a deployed position,
when the first guard rail is in the stowed position, the first guard rail is disposed below the ladder bridge mount, and
when the first guard rail is in the deployed position, the ladder bridge mount and the first guard rail are perpendicular to each other.

4. The modular ladder system of claim 3, wherein when the first guard rail is in the deployed position, the first guard rail is configured to attach to a first side of the swing gate.

5. The modular ladder system of claim 4, wherein the at least one adaptable part further comprises a second guard rail that is operable to transition between a stowed position and a deployed position,
when the second guard rail is in the stowed position, the second guard rail is disposed below the ladder bridge mount, and
when the second guard rail is in the deployed position, the ladder bridge mount and the second guard rail are perpendicular to each other.

6. The modular ladder system of claim 5, wherein when the second guard rail is in the deployed position, the second guard rail is configured to attach to a second side of the swing gate.

7. The modular ladder system of claim 1, wherein the vertical support and the angled ladder are configured to be detachably connected to one another.

8. The modular ladder system of claim 7, wherein the angled ladder comprises an extension plate pivotably mounted to the angled ladder at a position between the swing gate and the ladder bridge mount, and wherein the extension plate is alignable with the ladder bridge mount.

9. The modular ladder system of claim 8, wherein the at least one adaptable part comprises a second guard rail that is operable to transition between a stowed position and a deployed position, and
when the second guard rail is in the deployed position, the second guard rail is perpendicular to the extension plate.

10. The modular ladder system of claim 1, wherein the angled ladder comprises a base frame and a ladder, and wherein the ladder is supported by and attached to the base frame at an angle of about 75 degrees.

11. The modular ladder system of claim 2, wherein the foldable hinged step cover comprises a plate rest to rest over the second section of the semiconductor process system, and the plate rest is attached to the second section of the semiconductor process system.

12. A method of deploying a modular ladder system, the method comprises:
determining a type of a processing module of a semiconductor processing system;
deploying an adaptable part of the modular ladder system according to the type of the processing module; and then
attaching the modular ladder system to a first section of the semiconductor processing system.

13. The method of claim 12, wherein deploying the adaptable part of the modular ladder system comprises:
providing a foldable hinged step cover coupled to a ladder bridge mount of the modular ladder system; and
positioning the foldable hinged step cover to an inward position such that a portion of a top surface of the foldable hinged step cover faces a top surface of the ladder bridge mount, and
wherein the method further comprises, after attaching the modular ladder system to the first section of the semiconductor processing system, positioning the foldable hinged step cover in an outward position such that the top surface of the foldable hinged step cover is coplanar with the top surface of the ladder bridge mount and is coupled with a second section of the semiconductor processing system.

14. The method of claim 12, wherein deploying the adaptable part of the modular ladder system comprises:
providing a first guard rail coupled to a ladder bridge mount of the modular ladder system; and
stowing the first guard rail in a stowed position below the ladder bridge mount, and
wherein the method further comprises:
after attaching the modular ladder system to the first section of the semiconductor processing system, deploying the first guard rail in a deployed position, according to the type of the processing module, such that the first guard rail and the ladder bridge mount are perpendicular to each other; and
attaching the first guard rail to a first side of a swing gate of the modular ladder system.

15. The method of claim 14, wherein deploying the adaptable part on the modular ladder system further comprises:
providing a second guard rail coupled to the ladder bridge mount; and
stowing the second guard rail in a stowed position below the ladder bridge mount, and
wherein the method further comprises:
after attaching the modular ladder system to the first section of the semiconductor processing system, deploying the second guard rail in a deployed position, according to the type of the processing module, such that the second guard rail and the ladder bridge mount are perpendicular to each other; and then
attaching the second guard rail to a second side of the swing gate of the modular ladder system.

16. The method of claim 12, wherein deploying the adaptable part of the modular ladder system comprises:
detaching a vertical support and an angled ladder of the modular ladder system; and
deploying an extension plate to be pivotably fixed to the angled ladder at a location between a swing gate and a ladder bridge mount of the modular ladder system, wherein a top surface of the extension plate is coplanar with a top surface of the ladder bridge mount.

17. The method of claim 12, wherein attaching the modular ladder system to the first section of the semiconductor processing system comprises utilizing a latch to attach a ladder bridge mount of the modular ladder system to the first section of the semiconductor processing system.

18. A fall prevention system comprising:
a modular ladder system configured to provide access to a process module of a semiconductor process system, wherein the modular ladder system comprises:
a vertical support comprising a plurality of leg supports and a ladder bridge mount supported by the plurality of leg supports;
a base frame coupled to the ladder bridge mount;
a ladder coupled to the base frame, the ladder being supported by and attached to the base frame at an angle; and
at least one adaptable part coupled to the ladder bridge mount, wherein the at least one adaptable part is configured to provide a fall prevention barrier between the modular ladder system and a service alley.

19. The fall prevention system of claim 18, wherein the at least one adaptable part coupled to the ladder bridge mount comprises:
at least one guard rail coupled to a first side of the ladder bridge mount; and/or
a foldable hinged step cover coupled to a second side of the ladder bridge mount.

20. The fall prevention system of claim 18, wherein the ladder bridge mount is configured to dock with a section of a semiconductor processing system.
